(19) United States
(12) Patent Application Publication
(10) Pub. No.: US 2007/0241552 A1
(43) Pub. Date: Oct. 18, 2007

(54) Blister Pack Label

(75) Inventors: Paul Watson, Kent (GB); Jonathan Bobbett, Kent (GB)

Correspondence Address: CONNOLLY BOVE LODGE & HUTZ LLP, 1875 EYE STREET, N.W., SUITE 1100, WASHINGTON, DC, 20036, US

(73) Assignee: 3 Point Blie Limited, Kent (GB)

(21) Appl. No.: 10/575,228

(22) PCT Filed: Oct. 8, 2004
(86) PCT No.: PCT/GB04/50016

§ 371 Date: Feb. 20, 2007

(30) Foreign Application Priority Data
Oct. 8, 2003 (GB) 0323576.9

(51) Int. Cl. B42D 15/00

(52) U.S. Cl. 283/81; 206/531

(57) ABSTRACT

The present invention relates to a label (20) for a blister pack. In particular, it relates to a label which makes it more difficult for a child to release a medicament from the blister pack without making it unduly difficult for the elderly or infirm to remove the medicament. We describe a medicament blister pack label comprising a first sheet having first and second faces and a second sheet (22) having first and second faces, wherein the first face of the second sheet and the second face of the first sheet are opposed and bonded together; wherein at least portions of the first face of the first sheet are provided with a permanent adhesive (24); and wherein the sheet includes lines of weakness (30) defining medicament release zones.

The present invention relates to a label for a blister pack. In particular, it relates to a label which makes it more difficult for a child to release a medicament from the blister pack without making it unduly difficult for the elderly or infirm to remove the medicament.

Conventional blister cards or packs typically include a plastics sheet material moulded to provide a plurality of recesses into each of which recesses is placed a medicament, typically in tablet or capsule form. The medicaments are held in place by means of a foil retaining sheet which also provides an air-tight seal, maintaining sterility. When the patient wishes to use the medicament, they push the tablet or capsule through the foil retaining sheet For ease of release, the foil retaining sheet is usually rather thin and easily ruptured. This raises issues of child safety as it becomes very easy for a child to tamper with the blister pack, so releasing the medication. One approach to improving the child-resistance of a blister pack is to increase the thickness of the foil in order to require greater strength in order to push the medicament through the foil retaining sheet. However, one needs to be careful to avoid producing a blister pack from which elderly or infirm might find it impossible to gain access to their medicament.

Accordingly, there is a need to provide a blister card that provides resistance to tampering by children but allows the elderly or infirm to release their medicament without undue difficulty. WO 02/32666 describes one approach in which a first sheet material is attached to the foil of a conventional blister pack by a temporary adhesive. The first sheet covers all of the individual medicament recesses, but is itself of smaller overall dimensions than the blister pack itself. Overlaying the first sheet is a second sheet material. This is provided with a permanent adhesive and is larger than the first sheet material such that where it overlies the first sheet, it is adhered thereto by the permanent adhesive, but where it does not overlie the first sheet, it adheres by the permanent adhesive to the foil retaining sheet of the blister pack. The second sheet is perforated or scored in the area around where it overlies each medicament recess. The user peels off a portion of the second sheet adjacent the location of a medicament The perforations ensure selective removal only of that part adjacent the chosen medicament and the use of a permanent adhesive provides that a respective portion of the first sheet material is also removed. The user can then press the medicament through the foil layer as usual.

However, the arrangement of WO 02/32666 requires careful cutting and assembly of the components. The present invention seeks to provide an alternative blister pack label.

In its broadest sense, the present invention provides a medicament blister pack label comprising a first sheet having first and second faces and a second sheet having first and second faces, wherein the first face of the second sheet and the second face of the first sheet are opposed and bonded together and wherein at least portions of the first face of the first sheet are provided with a permanent adhesive. The sheet includes lines of weakness defining medicament release zones.

In one embodiment, the first face of the first sheet is fully coated with a permanent adhesive.

In an alternative embodiment, the first face of the first sheet is provided with a permanent adhesive only in those areas not adjacent to the medicament release zones. In a modification to this embodiment, those areas upon which a permanent adhesive is not provided are provided with a temporary or removable adhesive.

Suitably, the permanent adhesive is an acrylic emulsion adhesive. Alternatively, the adhesive may be a spirit-based permanent adhesive.

Suitably the first and second sheets are bonded by means of a permanent adhesive.

Typically, the lines of weakness defining medicament release zones comprise perforations or slits. Preferably, the lines of weakness penetrate the full thickness of the label.

Preferably, the label further comprises a release sheet or backing paper opposing the first face of the first sheet Suitably, the release sheet or backing paper comprises a sheet material having a silicone coating.

Preferably, the first sheet is a synthetic material, more preferably a polymeric or plastics sheet material. Most preferably, the first sheet is a polyethylene or polypropylene sheet. Most preferably still, the first sheet is a bi-directional polypropylene sheet material.

Preferably, the first sheet has a weight of from 15 to 100 g/m²; more preferably from 20 to 50 g/m²; even more preferably about 30 g/m².

Preferably, the first sheet has a thickness of from 15 to 120 μm; more preferably form 20 to 60 μm; even more preferably about 30 μm.

Preferably, the second sheet is a printable material, more preferably a paper material. Suitably the paper material is a machine-coated or blade-coated paper.

Preferably, the paper has a weight of 20 g/m² or more, more preferably from 50 to 400 g/m²; even more preferably from 60 to 200 g/m², most preferably from 70 to 150 g/m². Advantageously, the paper has a weight of from 80 to 120 g/m², suitably about 85 g/m².

Preferably, the second sheet has a thickness of from 20 to 400 μm; more preferably from 50 to 150 μm; even more preferably from 60 to 100 μm.

In a further aspect, the present invention provides a medicament blister pack comprising a moulded plastics tray including a plurality of moulded cavities or recesses each containing a medicament, said medicament being held in place by means of a foil retaining sheet, further comprising a label as described above.

The above and other aspects of the present invention will now be illustrated in further detail, by way of example only, with reference to the accompanying drawings in which:

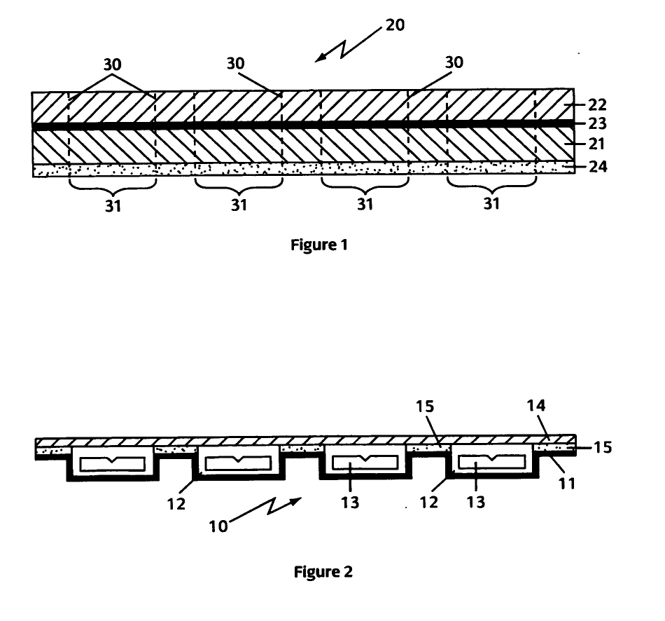

FIG. 1 is a schematic sectional view of a first embodiment of a label in accordance with the present invention;

FIG. 2 is a schematic sectional view of a conventional blister pack;

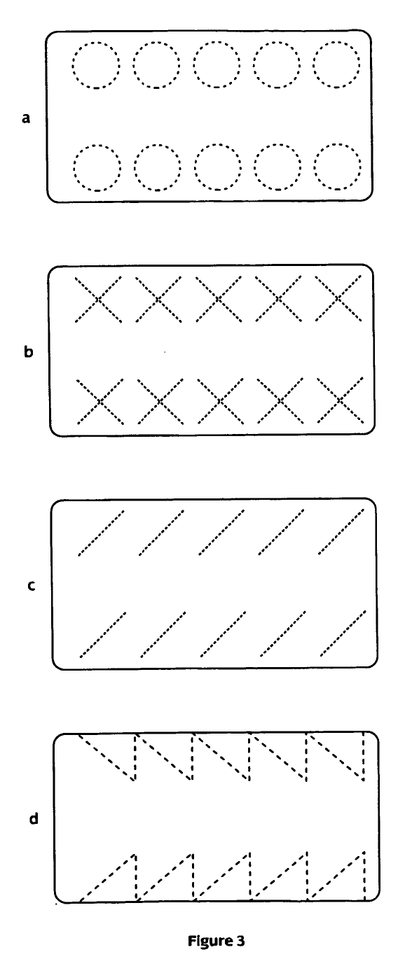

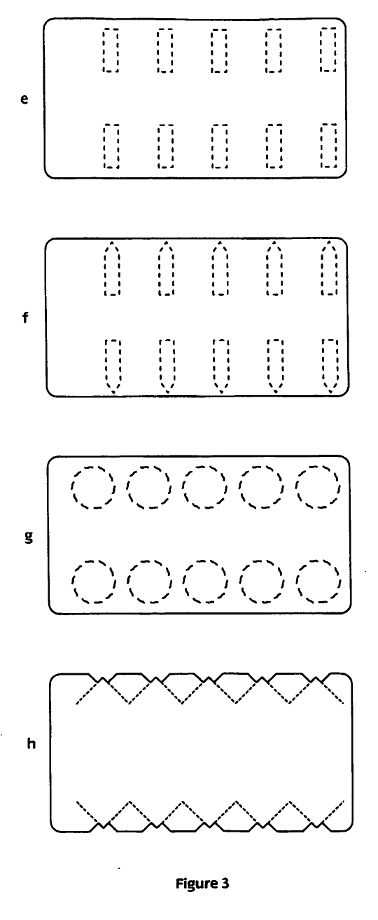

FIG. 3 shows, in views a to h, plan views of embodiments of labels in accordance with the present invention illustrating various arrangements for the lines of weakness;

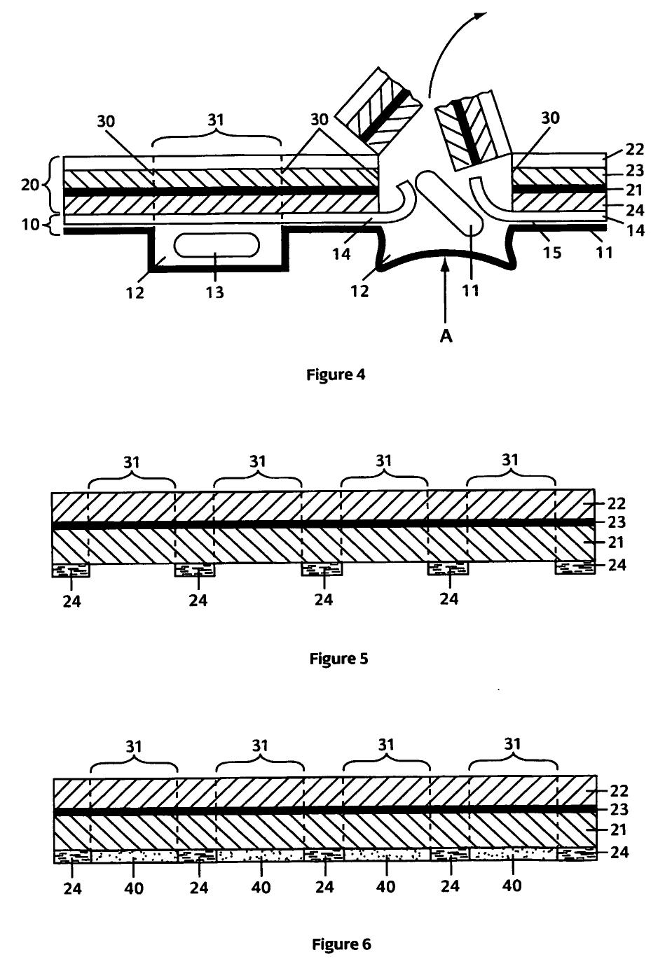

FIG. 4 is a schematic sectional view of blister pack comprising a first embodiment of the label of FIG. 1;

FIG. 5 is a schematic sectional view of a second embodiment of a label in accordance with the present invention; and

FIG. 6 is a schematic sectional view of a third embodiment of a label in accordance with the present invention.

Referring to FIG. 2, there is shown a conventional blister pack 10 comprising a moulded plastics tray 11 including a plurality of moulded cavities or recesses 12 each containing a medicament in the form of a capsule or tablet 13. The tablets are held in place by means of a foil retaining sheet 14. Retaining sheet 14 is adhered to tray 11 by means of adhesive 15 applied to the tray.

A first embodiment of a label 20 in accordance with the present invention is shown in FIG. 1. The label includes a first label sheet 21 bonded to a second label sheet 22. In the embodiment shown, the first and second label sheets are bonded by means of an adhesive layer 23. However other means of bonding may be suitable, for example, corona discharge, depending upon the nature of the materials constituting the first and second sheets 21,22.

In the preferred embodiment, first sheet 21 is a polymeric material such as polyethylene or polypropylene. A bi-directional polypropylene sheet having a thickness of about 50-60 μm and a weight (or grammage) of about 60 g/m² is particularly suitable.

Second sheet 22 is preferably a sheet material having a printable surface, such as a paper material. Wood or pulp based materials are particular preferred, but synthetic materials, such as Tyvek® are equally useable. Coated papers, such as gloss or semi-gloss machine-coated or blade-coated papers are preferred, such as semi-gloss machine coated paper having a thickness of about 75 μm and a weight (grammage) of 80-90 g/m².

A permanent adhesive 24 is applied to the exposed surface of first sheet 21. Any adhesive composition compatible with the material from which first sheet 21 is formed is suitable. For example all acrylic emulsion adhesive is suitable for use with a polypropylene sheet 21.

Lines of weakness 30 such as perforations or slits are formed in the label to define a plurality of medicament release zones 31, each zone 31 corresponding to the location of a medicament when the label is applied to the blister pack 10.

FIG. 3 shows, in views (a) to (h) a number of exemplary lines of weakness 30 formed in labels 20 of the present invention. The lines of weakness can range from simple lines of slits (3c), crosses (3b), and circles (3a) of slits, to more complex arrangements such as those shown in FIGS. 3d to 3h.

FIG. 4 illustrates the use of the label 20 of the present invention applied to a blister pack 10 containing a medicament 11. In use, the patient applies a force to the underside of the blister pack adjacent a recess 12 (as shown by Arrow A). The force applied allows the label 20 to fracture along the lines of weakness 30 and allows, in a conventional manner, the tablet 11 to perforate the foil 14 of the blister pack 10, so releasing the tablet 11.

An alternative embodiment is illustrated in FIG. 5. In this embodiment, those areas of the first sheet 21 forming the medicament release zone are not provided with any adhesive. A yet further alternative embodiment is illustrated in FIG. 6 in which those areas of the first sheet 21 forming the medicament release zone are provided with a temporary adhesive 40.

The absence of adhesive or use of a temporary adhesive means that the label can be used either as a peel-away label of the type described in WO 02/32666 or as the push-through type described above.

The sheet of the present invention may include further bonded layers intermediate the first 21 and second 22 layers described above.

The use of a printable second layer 22 allows patient information and/or product branding material to be printed onto the label 20.

1. A medicament blister pack label comprising a first sheet having first and second faces and a second sheet having first and second faces, wherein the first face of the second sheet and the second face of the first sheet are opposed and bonded together; wherein at least portions of the first face of the first sheet include a permanent adhesive; and wherein the sheet includes lines of weakness defining medicament release zones.

2. A medicament blister pack label according to claim 1 wherein the first face of the first sheet is fully coated with a permanent adhesive.

3. A medicament blister pack label according to claim 1 wherein the first face of the first sheet includes the permanent adhesive only in those areas not adjacent to the medicament release zones.

4. A medicament blister pack label according to claim 3 wherein areas of the first face of the first sheet which do not include the permanent adhesive include a temporary or removable adhesive.

5. A medicament blister pack label according to claim 1 wherein the permanent adhesive is an acrylic emulsion permanent adhesive or a spirit-based permanent adhesive.

6. A medicament blister pack label according to claim 1 wherein the first and second sheets are bonded by means of a second permanent adhesive.

7. A medicament blister pack label according to claim 1 wherein the lines of weakness defining medicament release zones comprise perforations or slits.

8. A medicament blister pack label according to claim 7 wherein the lines of weakness penetrate a full thickness of the label.

9. A medicament blister pack label according to claim 1 wherein the label comprises a release sheet opposing the first face of the first sheet.

10. A medicament blister pack label according to claim 9 wherein the release sheet comprises a sheet material having a silicone coating.

11. A medicament blister pack label according to claim 1 wherein the first sheet is made of a material selected from the group consisting of: a synthetic material, a polymeric material and a plastic material.

12. A medicament blister pack label according to claim 11 wherein the first sheet is made of a material selected from the group consisting of: polyethylene, polypropylene and bi-directional polypropylene.

13. A medicament blister pack label according to claim 1 wherein the first sheet has a weight selected from the group consisting of: 15 to 100 g/m², 20 to 50 g/m² and about 30 g/m².

14. A medicament blister pack label according to claim 1 wherein the first sheet has a thickness selected from the group consisting of: 15 to 120 μm, 20 to 60 μm and about 30 μm.

15. A medicament blister pack label according to claim 1 wherein the second sheet comprises a printable material.

16. A medicament blister pack label according to claim 15 wherein the second sheet is a paper material.

17. A medicament blister pack label according to claim 1 wherein second sheet has a weight selected from the group consisting of: 50 g/m² or more, 50 to 400 g/m², 60 to 200 g/m² and 70 to 150 g/m².

18. A medicament blister pack label according to claim 17 wherein second sheet has a weight selected from the group consisting of: 80 to 120 g/m² and about 85 g/m².

19. A medicament blister pack label according to claim 1 wherein the second sheet has a thickness selected from the group consisting of: 50 to 400 μm, 50 to 150 μm and 60 to 100 μm.

20. A medicament blister pack comprising:
a molded plastics tray including a plurality of molded cavities or Recesses, wherein each of said plurality of molded cavities or recesses contains a medicament, said medicament being held in place by a foil retaining sheet; and
a label as claimed in claim 1.
